(19) United States
(12) Patent Application Publication
(10) Pub. No.: US 2025/0247123 A1
(43) Pub. Date: Jul. 31, 2025

(54) RADIO FREQUENCY CIRCUIT AND ELECTRONIC DEVICE

(71) Applicant: VIVO MOBILE COMMUNICATION CO., LTD., Dongguan (CN)

(72) Inventors: Shougang CHENG, Dongguan (CN); Fei YIN, Dongguan (CN)

(73) Assignee: VIVO MOBILE COMMUNICATION CO., LTD., Dongguan (CN)

(21) Appl. No.: 19/083,428

(22) Filed: Mar. 18, 2025

Related U.S. Application Data
(63) Continuation of application No. PCT/CN2023/120775, filed on Sep. 22, 2023.

(30) Foreign Application Priority Data
Sep. 26, 2022 (CN) 202211172828.6

(51) Int. Cl. H04B 1/40; H04B 1/00; H04B 7/024; H04W 76/28

(52) U.S. Cl. CPC H04B 1/40; H04B 1/0067; H04B 7/024; H04W 76/28

(57) ABSTRACT

This application discloses a radio frequency circuit and an electronic device. The radio frequency circuit includes four antenna modules, and the four antenna modules are configured to receive a signal of a band B7 and a signal of a band n66 in parallel. A first antenna module of the radio frequency circuit includes a first receiving module, a second receiving module, and a first antenna. In a scenario of inter-band carrier aggregation CA in the band n66 and a dual connectivity ENDC combination of the band B7 and the band n66, the first antenna is connected to the first receiving module, and the first antenna module is configured to receive a signal of the band B7 and a signal of a first band in the band n66 in parallel.

### CROSS-REFERENCE TO RELATED APPLICATIONS

This application is a continuation of International Application No. PCT/CN2023/120775, filed Sep. 22, 2023, which claims priority to Chinese Patent Application No. 202211172828.6, filed Sep. 26, 2022. The entire contents of each of the above-referenced applications are expressly incorporated herein by reference.

### TECHNICAL FIELD

This application pertains to the field of communication technologies, and specifically relates to a radio frequency circuit and an electronic device.

### BACKGROUND

Currently, communication technology has evolved from 2G/3G/4G to 5G. 5G features high speed, low latency, and the like, which can provide a better user experience for terminal users. Network architectures of 5G can typically be categorized into two types: a standalone (SA) architecture and a non-standalone (NSA) architecture. In the NSA architecture, it is required that Long Term Evolution (LTE) and New Radio (NR) can send and receive signals in parallel.

In a related technology, when receiving LTE and NR signals in parallel, corresponding radio frequency circuits are typically set up in a terminal. However, for a dual connectivity (E-UTRAN New Radio Dual Connectivity, ENDC) combination of a band B7 (Band 7) and a band n66, radio frequency circuits for receiving signals of the two bands in parallel are complex and difficult to implement.

### SUMMARY

Embodiments of this application aim to provide a radio frequency circuit and an electronic device.

According to a first aspect, an embodiment of this application provides a radio frequency circuit. The radio frequency circuit includes four antenna modules, and the four antenna modules are configured to receive a signal of a band B7 and a signal of a band n66 in parallel. A first antenna module of the radio frequency circuit includes a first receiving module, a second receiving module, and a first antenna. In a scenario of inter-band carrier aggregation CA in the band n66 and a dual connectivity ENDC combination of the band B7 and the band n66, the first antenna is connected to the first receiving module, and the first antenna module is configured to receive a signal of the band B7 and a signal of a first band in the band n66 in parallel. In some embodiments, in a scenario of intra-band CA in the band n66, the first antenna is connected to the second receiving module, and the first antenna module is configured to receive a signal of the band n66.

According to a second aspect, an embodiment of this application provides an electronic device. The electronic device includes the radio frequency circuit according to the first aspect.

In the embodiments of this application, the radio frequency circuit includes four antenna modules configured to receive the signal of the band B7 and the signal of the band n66 in parallel. For the first antenna module in the four antenna modules, a receiving module in the first antenna module may be flexibly invoked for signal reception based on a receiving scenario of the signal of the band n66. In some embodiments, in a scenario of inter-band CA in the band n66 and an ENDC combination of the band B7 and the band n66, the signal of the band B7 and the signal of the first band in the band n66 may be received in parallel by using the first receiving module. In some embodiments, in a scenario of intra-band CA in the band n66, the signal of the band n66 may be received by using the second receiving module. In this way, the band n66 is divided into a narrowband (that is, the first band) and a broadband (that is, a full band), and different receiving modules are invoked for signal reception in different scenarios. This neither increases circuit complexity nor a quantity of antennas, so that external components can be saved, and circuit costs can be reduced. In addition, an insertion loss of a radio frequency path is reduced, radio frequency performance is improved, and user experience is effectively improved.

### BRIEF DESCRIPTION OF DRAWINGS

FIG. 1 is a schematic diagram of a structure of a radio frequency circuit for implementing an embodiment of this application;

FIG. 2 is a schematic diagram of a structure of a radio frequency circuit for implementing an embodiment of this application;

FIG. 3 is a schematic diagram of a structure of a first antenna module for implementing an embodiment of this application;

FIG. 4 is a schematic diagram of a flow direction of a radio frequency signal of a first antenna module for implementing an embodiment of this application;

FIG. 5 is a schematic diagram of a flow direction of a radio frequency signal of a first antenna module for implementing an embodiment of this application; and

FIG. 6 is a schematic diagram of a structure of a radio frequency circuit for implementing an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In this specification and claims of this application, the terms such as “first” and “second” are used for distinguishing similar objects, and are not necessarily used to describe a particular order or sequence. It should be understood that terms used in such a way are interchangeable in proper circumstances, so that embodiments of this application can be implemented in an order other than the order illustrated or described herein. Objects classified by “first”, “second”, and the like are usually of a same type, and a quantity of objects is not limited. For example, there may be one or more first objects. In addition, in this specification and the claims, “and/or” indicates at least one of connected objects, and a character “/” generally indicates an “or” relationship between associated objects.

In a related technology, when a signal of a band B7 and a signal of a band n66 are received in parallel, given a lack of a corresponding broadband combiner in a terminal, an antenna or a duplexer and a combiner are added to an existing radio frequency circuit (including four antennas) for parallel reception of the signal of the band B7 and the signal of the band n66. For a manner of adding an antenna, in some embodiments, a component that is in an antenna module of an existing radio frequency architecture and that is used for receiving a signal of the band n66 is separately detached, and then the newly added antenna is connected to the detached n66 component. In this way, parallel reception of the signal of the band B7 and the signal of the band n66 may be implemented by using five antennas. For a manner of adding a duplexer and a combiner, in some embodiments, a B7 duplexer and a combiner are added on the basis of an antenna module of an existing radio frequency architecture. The combiner is configured to combine the B7 duplexer and an n66 duplexer in the antenna module. In this way, parallel reception of the signal of the band B7 and the signal of the band n66 may be implemented by using four antennas.

However, during actual application, the first scheme described above requires five antennas for parallel reception of the signal of the band B7 and the signal of the band n66, which is difficult to implement, while the second scheme described above not only has higher costs, but also increases a layout area and a radio frequency path loss due to the need to add the duplexer and the combiner.

It can be learned that a current radio frequency circuit is complex and difficult to implement when receiving the signal of the band B7 and the signal of the band n66 in parallel.

In view of this, the embodiments of this application provide a radio frequency circuit and an electronic device. The band n66 is divided into a narrowband (that is, the first band in the band n66, 2110 MHz to 2180 MHz) and a broadband (that is, a full band of the band n66, 2110 MHz to 2200 MHZ), and different receiving modules are invoked for signal reception in different scenarios. This neither increases circuit complexity nor a quantity of antennas, so that external components can be saved, and circuit costs can be reduced. In addition, an insertion loss of a radio frequency path is reduced, radio frequency performance is improved, and user experience is effectively improved.

With reference to the accompanying drawings, a radio frequency circuit and an electronic device provided in the embodiments of this application are described in detail below by using a specific embodiment and an application scenario thereof.

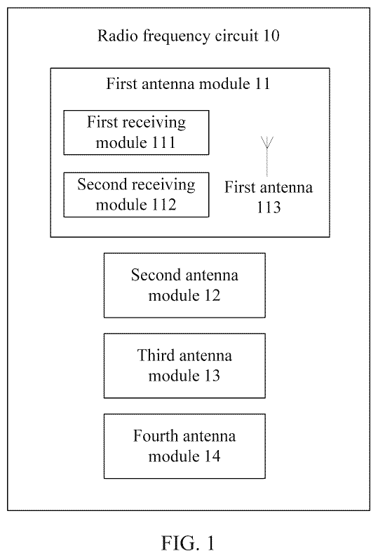

FIG. 1 is a schematic diagram of a structure of a radio frequency circuit for implementing an embodiment of this application.

As shown in FIG. 1, the radio frequency circuit 10 provided in this embodiment of this application includes four antenna modules: a first antenna module 11, a second antenna module 12, a third antenna module 13, and a fourth antenna module 14, respectively. The four antenna modules may be configured to receive a signal of a band B7 and a signal of a band n66 in parallel. Both the band B7 and the band n66 are downlink bands, the band B7 is 2620 MHz to 2690 MHz, and the band n66 is 2110 MHz to 2200 MHz.

The first antenna module 11 shown in FIG. 1 includes a first receiving module 111, a second receiving module 112, and a first antenna 113. The first antenna 113 may be connected to the first receiving module 111 or the second receiving module 112 based on an application scenario. In some embodiments, the band n66 may be divided into a narrowband (that is, a first band, a part of the band n66) and a broadband (that is, a full band of the band n66). In a scenario of inter-band Carrier Aggregation (CA) in the band n66 and a dual connectivity (E-UTRAN New Radio Dual Connectivity, ENDC) combination of the band B7 and the band n66, the first antenna 113 is connected to the first receiving module 111 (the second receiving module 112 may be in a suspended state). In this case, the first antenna module 11 may be configured to receive the signal of the band B7 and the signal of the first band in the band n66 in parallel. In a scenario of intra-band CA in the band n66, the first antenna 113 is connected to the second receiving module 112 (the first receiving module 111 may be in a suspended state). In this case, the first antenna module 11 may be configured to receive the signal of the band n66.

In this way, the band n66 is divided into a narrowband (that is, the first band) and a broadband (that is, a full band), and different receiving modules are invoked for signal reception in different scenarios. This neither increases circuit complexity nor a quantity of antennas, so that external components can be saved, and circuit costs can be reduced. In addition, an insertion loss of a radio frequency path is reduced, radio frequency performance is improved, and user experience is effectively improved.

In an embodiment, the first receiving module 111 shown in FIG. 1 may include a B1 receiving unit and a B7 receiving unit (not shown in FIG. 1). The B1 receiving unit may be configured to receive the signal of the first band in the band n66, and the B7 receiving unit may be configured to receive the signal of the band B7. To be specific, in a case that the first antenna 113 is connected to the first receiving module 111, the first receiving module 111 may receive the signal of the first band in the band n66 by using the internal B1 receiving unit, and receive the signal of the band B7 by using the internal B7 receiving unit, so as to implement parallel reception of the signal of the band B7 and the signal of the first band in the band n66.

In an embodiment, the first band in the band n66 may be 2110 MHz to 2180 MHz, and the first band basically overlaps a band B1 (a downlink band, 2110 MHz to 2170 MHz). In this way, in a scenario of inter-band CA in the band n66 and an ENDC combination of the band B7 and the band n66, a signal of the band 2110 MHz to 2180 MHz in the band n66 may be received by using the B1 receiving unit that is in the radio frequency circuit and that is configured to receive a signal of the band B1, that is, reception of the signal of the band 2110 MHz to 2180 MHz in the band n66 and reception of the signal of the band B1 share a path of the band B1 (that is, the B1 receiving unit). Therefore, there is no need to add an additional component, thereby reducing circuit costs and circuit complexity.

In an embodiment, the second receiving module 112 shown in FIG. 1 may include an n66 receiving unit (not shown in FIG. 1). The n66 receiving unit may be configured to receive the signal of the band n66. To be specific, in a case that the first antenna 113 is connected to the second receiving module 112, the second receiving module 112 may receive the signal of the band n66 by using the internal n66 receiving unit. In other words, in a scenario of intra-band CA in the band n66, the first antenna module 11 receives the signal of the band n66 not by using the first receiving module 111, but by using the n66 receiving unit in the second receiving module 112 outside the first receiving module 111.

It should be noted that in the 3rd Generation Partnership Project (3GPP), it is required that in a scenario of intra-band CA in the band n66, signal reception needs to cover the full band (2110 MHz to 2200 MHZ) of the band n66. In a scenario of inter-band CA in the band n66, there may be no need for signal reception to cover the full band of the band n66. Therefore, in this embodiment of this application, in a scenario of inter-band CA in the band n66, the first receiving module receives a narrowband (that is, the first band) signal, and in a scenario of intra-band CA in the band n66, the second receiving module receives a wideband (that is, the full band of the band n66) signal, which can satisfy a 3GPP requirement.

In an embodiment, the first antenna module 11 shown in FIG. 1 may further include a switch unit (not shown in FIG. 1). The switch unit may include two connection ports. One connection port is connected to the first antenna 113, and the other connection port may be connected to the first receiving module 111 or the second receiving module 112. In some embodiments, the switch unit may be a single-pole double-throw switch.

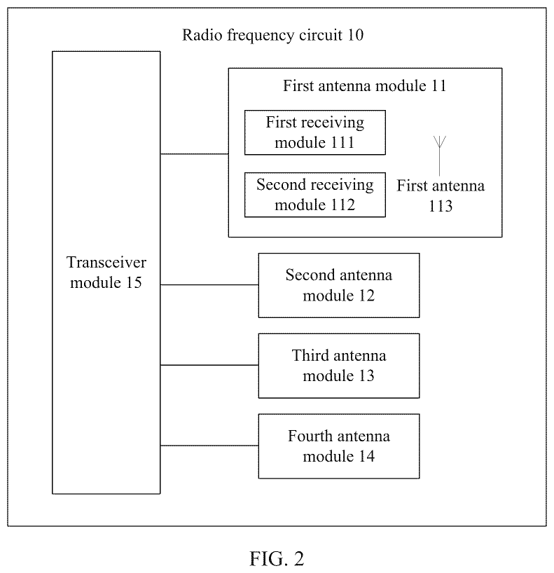

In an embodiment, the radio frequency circuit may further include a transceiver module. The first antenna module, the second antenna module, the third antenna module, and the fourth antenna module in the radio frequency circuit may be connected to the transceiver module in a parallel manner, as shown in FIG. 2. In FIG. 2, the first antenna module 11, the second antenna module 12, the third antenna module 13, and the fourth antenna module 14 in the radio frequency circuit may be connected to the transceiver module 15 in a parallel manner. The transceiver module 15 and the four antenna modules jointly implement parallel sending and receiving of the signal of the band B7 and the signal of the band n66.

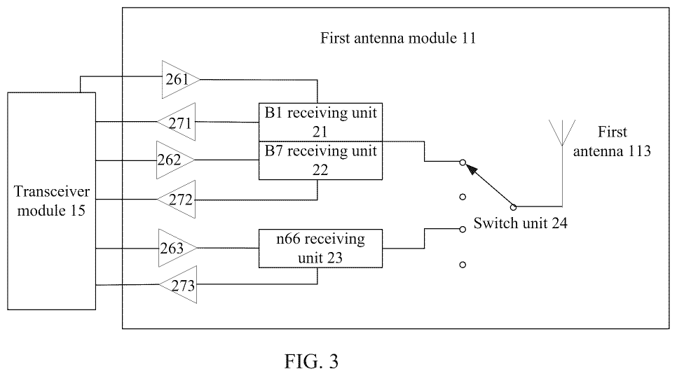

To facilitate understanding of the first antenna module provided in this embodiment of this application, in a more specific implementation, the first antenna module may be shown in FIG. 3.

FIG. 3 is a schematic diagram of a structure of a first antenna module for implementing an embodiment of this application. As shown in FIG. 3, the first antenna module 11 includes a B1 receiving unit 21, a B7 receiving unit 22, an n66 receiving unit 23, a switch unit 24, and a first antenna 113. In addition, the first antenna module 11 further includes power amplifiers (PAS) 261, 262, and 263 and Low Noise Amplifiers (LNAs) 271, 272, and 273. The B1 receiving unit 21 is connected to the transceiver module 15 through the PA 261 and the LNA 271, the B7 receiving unit 22 is connected to the transceiver module 15 through the PA 262 and the LNA 272, and the n66 receiving unit 23 is connected to the transceiver module 15 through the PA 263 and the LNA 273.

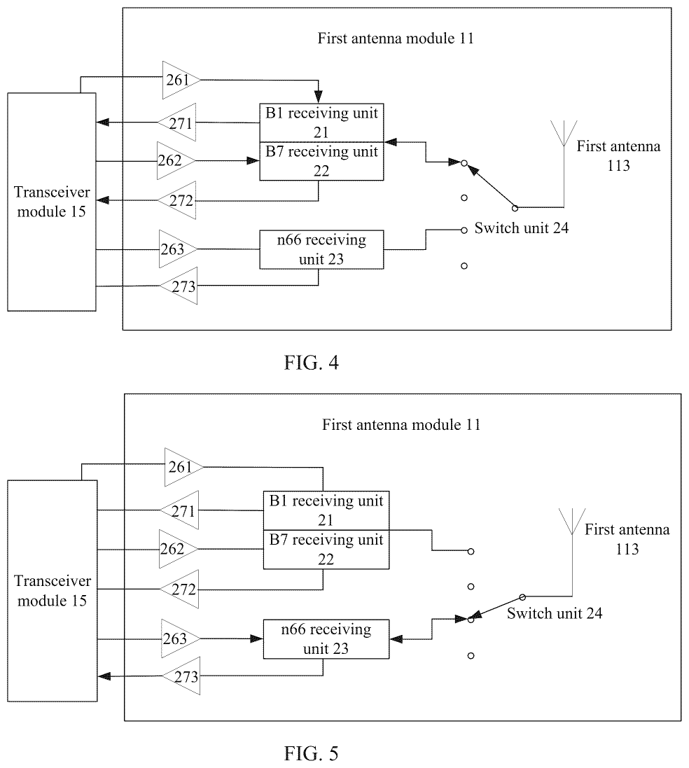

In the first antenna module 11 shown in FIG. 3, in a scenario of inter-band CA in the band n66 and an ENDC combination of the band B7 and the band n66, one end of the switch unit 24 is connected to the first antenna 113, and the other end is connected to the B1 receiving unit 21 and the B7 receiving unit 22, to receive a signal of the band B7 and a signal of a first band in the band n66 in parallel. For a specific flow direction of a radio frequency signal, refer to FIG. 4.

In FIG. 4, when the signal of the band B7 and the signal of the first band in the band n66 are received in parallel, the signal of the band B7 may enter the transceiver module 15 by sequentially passing through the first antenna 113, the switch unit 24, the B7 receiving unit 22, and the LNA 272, and the signal of the first band in the band n66 may enter the transceiver module 15 by sequentially passing through the first antenna 113, the switch unit 24, the B1 receiving unit 21, and the LNA 271. Correspondingly, when the signal of the band B7 and the signal of the first band in the band n66 are sent in parallel, the signal of the band B7 may be sent by sequentially passing through the transceiver module 15, the PA 262, the B7 receiving unit 22, the switch unit 24, and the first antenna 113, and the signal of the first band in the band n66 may be sent by sequentially passing through the transceiver module 15, the PA 261, the B1 receiving unit 21, the switch unit 24, and the first antenna 113.

In a scenario of intra-band CA in the band n66, one end of the switch unit 24 is connected to the first antenna 113, and the other end is connected to the n66 receiving unit 23, to receive the signal of the band n66. For a specific flow direction of a radio frequency signal, refer to FIG. 5.

In FIG. 5, when the signal of the band n66 is received, the signal of the band n66 may enter the transceiver module 15 by sequentially passing through the first antenna 113, the switch unit 24, the n66 receiving unit 23, and the LNA 273. Correspondingly, when the signal of the band n66 is sent, the signal of the band n66 may sequentially pass through the transceiver module 15, the PA 263, the n66 receiving unit 23, the switch unit 24, and the first antenna 113.

It should be noted that, during actual application, it is considered that radio frequency circuits in different terminal devices may have different parameters at factory setting. Before receiving a signal by using a radio frequency circuit, a parameter of a receiving path of the radio frequency circuit may be calibrated. For example, parameters of paths corresponding to the flow directions of radio frequency signals shown in FIG. 4 and FIG. 5 are calibrated. In this way, when receiving a signal by using a corresponding path, the signal may be received based on a calibrated parameter.

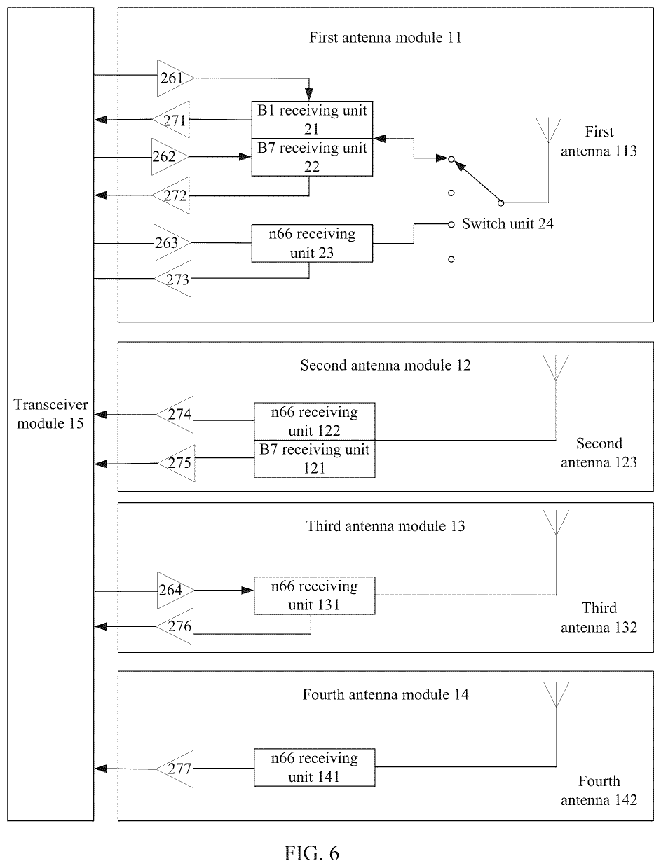

In this embodiment of this application, the first antenna module, the second antenna module, the third antenna module, and the fourth antenna module included in the radio frequency circuit may jointly implement parallel sending and receiving of the signal of the band B7 and the signal of the band n66. The second antenna module, the third antenna module, and the fourth antenna module may also include a corresponding receiving unit and an antenna. For details, refer to FIG. 6.

FIG. 6 is a schematic diagram of a structure of a radio frequency circuit for implementing an embodiment of this application. The radio frequency circuit shown in FIG. 6 includes a first antenna module 11, a second antenna module 12, a third antenna module 13, a fourth antenna module 14, a transceiver module 15, PA 261 to PA 264, and LNA 271 to LNA 277. The first antenna module 11 includes a B1 receiving unit 21, a B7 receiving unit 22, an n66 receiving unit 23, a switch unit 24, and a first antenna 113. For details, refer to the first antenna module 11 shown in FIG. 1 and FIG. 3. Details are not described herein again. The second antenna module 12 includes a B7 receiving unit 121, an n66 receiving unit 122, and a second antenna 123, and the second antenna module 12 is configured to receive a signal of the band B7 and a signal of the band n66 in parallel. The third antenna module 13 includes an n66 receiving unit 131 and a third antenna 132, and the third antenna module 13 is configured to receive a signal of the band n66. The fourth antenna module 14 includes an n66 receiving unit 141 and a fourth antenna 142, and the fourth antenna module 14 is configured to receive a signal of the band n66. The first antenna module 11, the second antenna module 12, the third antenna module 13, and the fourth antenna module 14 are connected to the transceiver module 15 in a parallel manner.

Based on the radio frequency circuit shown in FIG. 6, when the signal of the band B7 and the signal of the band n66 are received in parallel, the signal of the band B7 may be received by using two antennas, and the signal of the band n66 may be received by using four antennas.

In some embodiments, in a more specific application scenario, the four antenna modules in the radio frequency circuit receiving the signal of the band B7 and the signal of the band n66 in parallel may be as follows: The first antenna module is used for Primary Receive (PRX) in the band B7 and PRX Multiple Input Multiple Output (MIMO) full-band reception in the band n66. The second antenna module is used for full-band reception in the band n66 and Diversity Receive (DRX) in the band B7. The third antenna module is used for full band PRX in the band n66. The fourth antenna module is used for DRX MIMO full-band reception in the band n66. In this way, MIMO parallel reception of 2*2 antennas in the band B7 and 4*4 antennas in the band n66 can be implemented.

In an embodiment, it is considered that the band n66 and the band B66 are the same, and the band B7 and the band n7 are the same. The radio frequency circuit provided in this embodiment of this application may be further configured to receive a signal of the band B66 and a signal of the band n7 in parallel. To be specific, on the basis of not changing a structure of the radio frequency circuit, a module/unit configured to receive a signal of the band n66 is configured to receive the signal of the band B66, and a module/unit configured to receive a signal of the band B7 is configured to receive the signal of the band n7. In some embodiments, the band B66 may be divided into a narrowband (that is, the first band) and a broadband (that is, a full band of the band B66) based on division of the narrowband and the broadband of the band n66. When receiving a signal, for the first antenna module in the radio frequency circuit, in a scenario of inter-band CA in the band B66 and an ENDC combination of the band B66 and the band n7, the first antenna in the first antenna module is connected to the first receiving module, and the first antenna module may be configured to receive a signal of a first band in the band B66 and a signal of the band n7 in parallel. In a scenario of intra-band CA in the band B66, the first antenna in the first antenna module is connected to the second receiving module, and the first antenna module may be configured to receive a signal of the band B66. In this way, the band B66 is divided into a narrowband (that is, the first band) and a broadband (that is, the full band), and different receiving modules are invoked for signal reception in different scenarios, so as to implement parallel reception of the signal of the band B66 and the signal of the band n7. This neither increases circuit complexity nor a quantity of antennas, so that external components can be saved, and circuit costs can be reduced. In addition, an insertion loss of a radio frequency path is reduced, radio frequency performance is improved, and user experience is effectively improved.

In a case that the radio frequency circuit is configured to receive the signal of the band B66 and the signal of the band n7 in parallel:

In some embodiments, the B1 receiving unit included in the first receiving module may be configured to receive a signal of the first band in the band B66, and the B7 receiving unit included in the first receiving module may be configured to receive the signal of the band n7. The first band is a band B1, that is, 2110 MHz to 2180 MHZ.

In some embodiments, the n66 receiving unit included in the second receiving module may be configured to receive the signal of the band B66.

In some embodiments, the second antenna module in the radio frequency circuit includes the B7 receiving unit, the n66 receiving unit, and the second antenna that may be configured to receive the signal of the band n7 and the signal of the band B66 in parallel. The n66 receiving unit and the third antenna included in the third antenna module may be configured to receive the signal of the band B66. The n66 receiving unit and the fourth antenna included in the fourth antenna module may be configured to receive the signal of the band B66.

In some embodiments, the first antenna module may be used for PRX in the band n7 and PRX MIMO full-band reception in the band B66. The second antenna module is used for full-band reception in the band B66 and DRX in the band n7. The third antenna module is used for full-band PRX in the band B66. The fourth antenna module is used for DRX MIMO full-band reception in the band B66.

In some embodiments, the radio frequency circuit further includes a transceiver module. The four antenna modules in the radio frequency circuit may be connected to the transceiver module in a parallel manner. The four antenna modules and the transceiver module may jointly implement parallel sending and receiving of the signal of the band B66 and the signal of the band n7.

For a specific implementation in which the radio frequency circuit is configured to receive the signal of the band B66 and the signal of the band n7 in parallel, refer to a specific implementation in which the radio frequency circuit is configured to receive the signal of the band n66 and the signal of the band B7 in parallel. Details are not described herein again.

The radio frequency circuit provided in the embodiments of this application includes four antenna modules configured to receive the signal of the band B7/n7 and the signal of the band n66/B66 in parallel. For the first antenna module in the four antenna modules, a receiving module in the first antenna module may be flexibly invoked for signal reception based on a receiving scenario of the signal of the band n66/B66. In some embodiments, in a scenario of inter-band CA in the band n66 and an ENDC combination of the band B7 and the band n66, the signal of the band B7/n7 and the signal of the first band in the band n66/B66 may be received in parallel by using the first receiving module. In some embodiments, in a scenario of intra-band CA in the band n66/B66, the signal of the band n66/B66 may be received by using the second receiving module. In this way, the band n66/B66 is divided into a narrowband (that is, the first band) and a broadband (that is, a full band), and different receiving modules are invoked for signal reception in different scenarios. This neither increases circuit complexity nor a quantity of antennas, so that external components can be saved, and circuit costs can be reduced. In addition, an insertion loss of a radio frequency path is reduced, radio frequency performance is improved, and user experience is effectively improved.

An embodiment of this application further provides an electronic device. The electronic device includes the radio frequency circuit described above.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A radio frequency circuit, comprising four antenna modules configured to receive a signal of a band B7 and a signal of a band n66 in parallel, wherein:
a first antenna module of the radio frequency circuit comprises a first receiving module, a second receiving module, and a first antenna; and
in a scenario of inter-band carrier aggregation (CA) in the band n66 and an E-UTRAN new radio dual connectivity (ENDC) combination of the band B7 and the band n66, the first antenna is connected to the first receiving module, and the first antenna module is configured to receive a signal of the band B7 and a signal of a first band in the band n66 in parallel; or
in a scenario of intra-band CA in the band n66, the first antenna is connected to the second receiving module, and the first antenna module is configured to receive a signal of the band n66.

2. The radio frequency circuit according to claim 1, wherein the first receiving module comprises a B1 receiving unit and a B7 receiving unit,
wherein the B1 receiving unit is configured to receive a signal of the first band, and the B7 receiving unit is configured to receive a signal of the band B7.

3. The radio frequency circuit according to claim 1, wherein the first band is 2110 MHz to 2180 MHz.

4. The radio frequency circuit according to claim 1, wherein the second receiving module comprises an n66 receiving unit, and the n66 receiving unit is configured to receive a signal of the band n66.

5. The radio frequency circuit according to claim 1, wherein the first antenna module further comprises a switch unit,
wherein one end of the switch unit is connected to the first antenna, and the other end of the switch unit is connected to the first receiving module or the second receiving module.

6. The radio frequency circuit according to claim 1, wherein:
a second antenna module of the radio frequency circuit comprises a B7 receiving unit, an n66 receiving unit, and a second antenna, and the second antenna module is configured to receive a signal of the band B7 and a signal of the band n66 in parallel;
a third antenna module of the radio frequency circuit comprises an n66 receiving unit and a third antenna, and the third antenna module is configured to receive a signal of the band n66; and
a fourth antenna module of the radio frequency circuit comprises an n66 receiving unit and a fourth antenna, and the fourth antenna module is configured to receive a signal of the band n66.

7. The radio frequency circuit according to claim 6, wherein:
the first antenna module is used for primary reception (PRX) in the band B7 and PRX multi-input multi-output (MIMO) full-band reception in the band n66;
the second antenna module is used for full-band reception in the band n66 and diversity reception (DRX) in the band B7;
the third antenna module is used for full-band PRX in the band n66; and
the fourth antenna module is used for DRX MIMO full-band reception in the band n66.

8. The radio frequency circuit according to claim 1, wherein the radio frequency circuit is further configured to receive a signal of a band B66 and a signal of a band n7 in parallel, wherein:
in a scenario of inter-band CA in the band B66 and the ENDC combination of the band B66 and the band n7, the first antenna is connected to the first receiving module, and the first antenna module is configured to receive a signal of a first band in the band B66 and a signal of the band n7 in parallel; or
in a scenario of intra-band CA in the band B66, the first antenna is connected to the second receiving module, and the first antenna module is configured to receive a signal of the band B66.

9. The radio frequency circuit according to claim 1, wherein the radio frequency circuit further comprises a transceiver module,
wherein the four antenna modules are connected to the transceiver module in a parallel manner, and the four antenna modules and the transceiver module are configured to send and receive a signal of the band B7 and a signal of the band n66 in parallel, or send and receive a signal of a band B66 and a signal of a band n7 in parallel.

10. An electronic device, comprising a radio frequency circuit, wherein the radio frequency circuit comprises four antenna modules configured to receive a signal of a band B7 and a signal of a band n66 in parallel, wherein:
a first antenna module of the radio frequency circuit comprises a first receiving module, a second receiving module, and a first antenna; and
in a scenario of inter-band carrier aggregation (CA) in the band n66 and an E-UTRAN new radio dual connectivity (ENDC) combination of the band B7 and the band n66, the first antenna is connected to the first receiving module, and the first antenna module is configured to receive a signal of the band B7 and a signal of a first band in the band n66 in parallel; or
in a scenario of intra-band CA in the band n66, the first antenna is connected to the second receiving module, and the first antenna module is configured to receive a signal of the band n66.

11. The electronic device according to claim 10, wherein the first receiving module comprises a B1 receiving unit and a B7 receiving unit,
wherein the B1 receiving unit is configured to receive a signal of the first band, and the B7 receiving unit is configured to receive a signal of the band B7.

12. The electronic device according to claim 10, wherein the first band is 2110 MHz to 2180 MHz.

13. The electronic device according to claim 10, wherein the second receiving module comprises an n66 receiving unit, and the n66 receiving unit is configured to receive a signal of the band n66.

14. The electronic device according to claim 10, wherein the first antenna module further comprises a switch unit,
wherein one end of the switch unit is connected to the first antenna, and the other end of the switch unit is connected to the first receiving module or the second receiving module.

15. The electronic device according to claim 10, wherein:
a second antenna module of the radio frequency circuit comprises a B7 receiving unit, an n66 receiving unit, and a second antenna, and the second antenna module is configured to receive a signal of the band B7 and a signal of the band n66 in parallel;
a third antenna module of the radio frequency circuit comprises an n66 receiving unit and a third antenna, and the third antenna module is configured to receive a signal of the band n66; and
a fourth antenna module of the radio frequency circuit comprises an n66 receiving unit and a fourth antenna, and the fourth antenna module is configured to receive a signal of the band n66.

16. The electronic device according to claim 15, wherein:
the first antenna module is used for primary reception (PRX) in the band B7 and PRX multi-input multi-output (MIMO) full-band reception in the band n66;
the second antenna module is used for full-band reception in the band n66 and diversity reception (DRX) in the band B7;
the third antenna module is used for full-band PRX in the band n66; and
the fourth antenna module is used for DRX MIMO full-band reception in the band n66.

17. The electronic device according to claim 10, wherein the radio frequency circuit is further configured to receive a signal of a band B66 and a signal of a band n7 in parallel, wherein:
in a scenario of inter-band CA in the band B66 and the ENDC combination of the band B66 and the band n7, the first antenna is connected to the first receiving module, and the first antenna module is configured to receive a signal of a first band in the band B66 and a signal of the band n7 in parallel; or
in a scenario of intra-band CA in the band B66, the first antenna is connected to the second receiving module, and the first antenna module is configured to receive a signal of the band B66.

18. The electronic device according to claim 10, wherein the radio frequency circuit further comprises a transceiver module,
wherein the four antenna modules are connected to the transceiver module in a parallel manner, and the four antenna modules and the transceiver module are configured to send and receive a signal of the band B7 and a signal of the band n66 in parallel, or send and receive a signal of a band B66 and a signal of a band n7 in parallel.
